(19) United States
(12) Patent Application Publication
(10) Pub. No.: US 2023/0096634 A1
(43) Pub. Date: Mar. 30, 2023

(54) ANTENNA ENCLOSURES FOR HEAD MOUNTABLE DEVICES

(71) Applicant: HEWLETT-PACKARD DEVELOPMENT COMPANY, L.P., Spring, TX (US)

(72) Inventors: Hung-Chi Shih, Taipei City (TW); Chien-Heng Chang Chien, Taipei City (TW); Chih-Hsin Lee, Taipei City (TW)

(73) Assignee: HEWLETT-PACKARD DEVELOPMENT COMPANY, L.P., Spring, TX (US)

(21) Appl. No.: 17/486,276

(22) Filed: Sep. 27, 2021

(51) Int. Cl. G02B 27/01; H01Q 1/27; H01Q 1/22

(52) U.S. Cl. CPC G02B 27/0176; H01Q 1/276; H01Q 1/2258

(57) ABSTRACT

In an example, a head mountable device (HMD), according to the disclosure, comprises a body, an antenna enclosure system which includes a first antenna enclosure having a first antenna and positioned to a first side of the body and a second antenna enclosure having a second antenna and positioned to a second side of the body, a wireless base unit housing a base band unit, and a cable to transfer at least one of data and power between the wireless base unit to the antenna enclosure system.

### BACKGROUND

Head mounted devices may be used to provide an altered reality to a user. An extended reality (XR) device may include a virtual reality (VR) device, an augmented reality (AR) device, and/or a mixed reality (MR) device. XR devices may include displays to provide a VR, AR, or MR experience to the user by providing video, images, and/or other visual stimuli to the user via the displays. XR devices may be worn by a user.

### BRIEF DESCRIPTION OF THE DRAWINGS

FIG. 1A is a perspective view of an example head mountable device (HMD) having an antenna enclosure system, according to an example.

FIG. 1B is a block diagram of an example HMD having an antenna enclosure system, according to an example.

FIG. 2 is an exploded view of an antenna system for an HMD, according to an example.

FIG. 3 is a perspective view of an example antenna enclosure for an antenna system of an HMD, according to an example.

FIG. 4 is a perspective view of an example antenna enclosure system fastened to an HMD, according to an example.

### DETAILED DESCRIPTION

Extended reality (XR) devices may provide an altered reality to a user by providing video, audio, images, and/or other stimuli to a user via a display. As used herein, the term “XR device” refers to a device that provides a virtual reality (VR), augmented reality (AR), and/or mixed reality (MR) experience for a user.

The XR device may be experienced by a user through the use of a head mount device (e.g., a headset). For example, a user may wear the headset in order to view the display of the XR device and/or experience audio stimuli of the XR device. As used herein, the term “extended reality” refers to a computing device generated scenario that simulates experience through senses and perception. In some examples, an XR device may cover a user's eyes and provide visual stimuli to the user via a display, thereby substituting an “extended” reality (e.g., a “virtual reality”, “augmented reality” and/or “mixed reality”) for actual reality.

In some examples, an XR device may be communicately coupled to a host computing device to exchange power and/or data which enhance the virtual reality experienced by the user. In some examples, a XR device may be physically tethered to the host computing device by a cable. However, tethering the user of the HMD to the host computing device limits the user's ability to move freely when interacting in an extended reality environment. Therefore, wireless solutions have been desired to enhance the user experience.

For example, an XR device may include a wireless person computer (PC) XR device which wirelessly exchanges power and data with the host computing device. In other examples, an XR device may include an all-in-one (AIO) XR device which operates independently from a host computing device for more immersive experiences. In some instances a high-end PC XR device may deliver the better quality visual, audio and motion tracking experiences than an AIO XR device since the PC XR device may be able to access more computing power than the AIO XR device. However, these high-end PC XR devices may require wireless technologies that are capable of providing wide data bandwidth, high transmission speed, and a transmission distance up five meter or more. Therefore, wireless antenna placement is usually above or outboard to the users head so as to get the direct “line of sight” for the directional signal from the HMD to the host computing device, and vice versa. This ensures that the transmitted signal is not blocked or attenuated by the head or headset.

With the large amounts of data that need to be transmitted or received between the transmitter on the host computing device and the antenna on the HMD, a beamforming technique is often required to intensify the electromagnetic radiation in the direct path from the transmitter to the receiver. Therefore, the antenna enclosure needs be placed where the transmitter of the HMD can get in the “line of sight” of a transmitter on a host computing device. Unfortunately, many integrated antenna designs used for XR wireless accessories tend to have bulky and prominent antenna enclosures which go against the downsizing and light-weight HMD design desired by users. Additionally, HMDs come in different sizes and shapes. Thus, the optimum antenna placement on the HMD may vary from one device to another, The disclosed antenna system for an HMD is designed to improve the cosmetic and performance for XR wireless accessories.

In an example, a head mountable device (HMD), according to the disclosure, comprises a body, an antenna enclosure system which includes a first antenna enclosure having a first antenna positioned to a first side of the body and a second antenna enclosure having a second antenna positioned to a second side of the body, a wireless base unit housing a base band unit, and a cable to transfer at least one of data and power between the wireless base unit to the antenna enclosure system.

In another example, antenna system for an XR HMD comprises a wireless base unit which located to a back side of a viewer's head and a battery connected to the wireless by unit by a battery cord. The antenna system further includes a data cable for exchanging data between the wireless base unit and a body of the HMD. The antenna system for the XR HMD also comprises a right antenna enclosure enclosing a right radio frequency (RF) connector which is communicately coupled to the wireless base unit by a right coaxial cable, wherein the right antenna enclosure is located to a right side of the viewer's head. The antenna system for the XR HMD also includes a left antenna enclosure enclosing a left RF connector which is communicately coupled to the wireless base unit by a left coaxial cable, wherein the left antenna enclosure is located to a left side of the viewer's head.

In yet another example, an XR HMD comprises a body, a head strap coupled to the body of the XR HMD, a main accessory piece housing a baseband unit attached to the head strap on a back side of a user's head, a right antenna enclosure coupled to the main accessory piece by a right cable and attached to the head strap on a right side of the user's head, and a left antenna enclosure coupled to the main accessory piece by a left cable and attached to the head strap on a left side of the user's head.

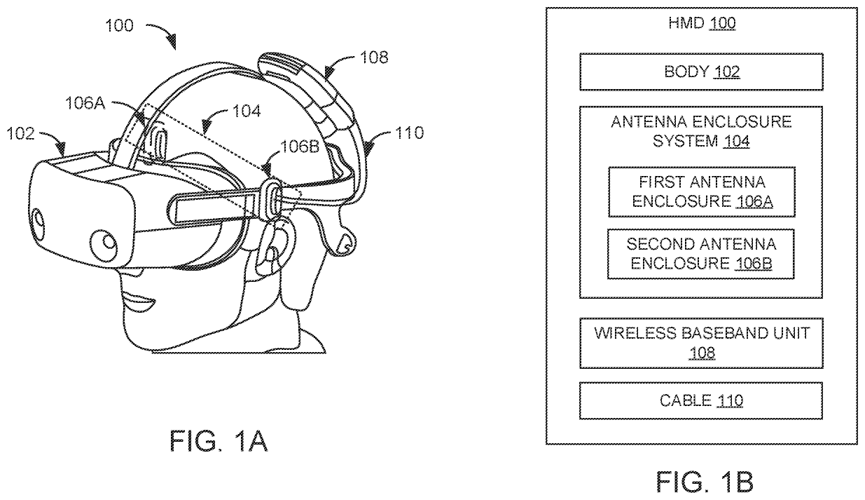

FIG. 1A is a perspective view of an example HMD having an antenna enclosure system, according to an example. HMD 100 includes body 102, antenna enclosure system 104 which includes first antenna enclosure 106A and second antenna enclosure 106B, wireless base unit 108, and cable 110,

As illustrated in FIG. 1A, HMD 100 rests on a user's head to view visuals on a display. As used herein, the term “body” refers to a component enclosing a display device. Body 102 rests on a user's face on the “front” of the user's head. Further, antenna enclosure system 104 includes first antenna enclosure 106A and second antenna enclosure 106E which are placed on the either “side” of the user's face/head. As further illustrated in FIG. 1A, wireless base unit 108 rests on the “back” of the user's head. Finally, cable 110 connects antenna enclosure system 104 to wireless base unit 108 to exchange power and/or data.

Referring to FIG. 1B, FIG. 1B is a block diagram of an example HMD having an antenna enclosure system, according to an example. Body 102 may comprise an XR display enclosure. Body 102 may further include a strip of material which covers at least a portion of a user's face which may enable a user to view a display in the HMD. For example, body 102 may include an inner surface made of foam, an inflatable bladder, or some other composition which creates a soft boundary between a hard coupling portion to body 102 and the user's face. The inner surface may be a surface that is located proximate to an upper portion of the user's face. For example, when a user wears HMD 100 the body 102 can surround the user's eyes and the inner surface.

Antenna enclosure system 104 includes first antenna enclosure 106A and second antenna enclosure 106B. First antenna enclosure 106A and second antenna enclosure 106B each comprise an enclosure housing an antenna. Each enclosure may be plastic, metal, or some other material which enables radio frequency (RF) waves to pass from the housed antenna to an external receiver and transmitter, such as on a host computing device.

First antenna enclosure 106A and second antenna enclosure 106B may also each enclose an antenna board. The antenna boards may each enclose an RF connector. The RF connectors may by connected to the antenna boards by dips or another fastener.

Antenna enclosure system 104 may transmit and receive signals with an external system, such as a host computing device, using Bluetooth, Wireless Fidelity (WiFi), Infrared (IR), Near Field Communication, Ultra-Wide Band, IEEE 802.11 wireless local area network (MAN), Wireless USB, ZigBee (IEEE 802.15.4, IEEE 802.15.4a), and ultra-high frequency radio frequency identification (UHF RFID) technologies, or any other short-range wireless protocol capable of transmitting and receiving wireless signals.

Although first antenna enclosure 106A and second antenna enclosure 106B are illustrated as fastening to a head strap of HMD 100, examples of the disclosure are not so limited. For example, first antenna enclosure 106A and second antenna enclosure 106B may be fastened to HMD 100 by attaching to ear-speakers or each-pieces on either side of the user's head.

In other examples, HMD 100 may include sidearms which secure body 102 to the user's face. In some examples of this instance, first antenna enclosure 106A and second antenna enclosure 106B may each attach to a sidearm on either side of the user's face. In some examples, each of first antenna enclosure 106A and second antenna enclosure 106B of antenna enclosure system 104 is attached to the first side of the body and to the second side of the body with straps (e.g., Velcro) or clips. Although HMD 100 includes first antenna enclosure 106A and second antenna enclosure 106B, multiple antenna enclosures housing antennas may be included in HMD100.

Wireless base unit 108 houses the base band unit (BBU) and other wireless processing circuitry, such as an RF processing unit. Wireless base unit 108 may comprise a Bluetooth base unit, a WiFi base unit, a remote radio unit (RRU), or any other wireless base unit. Wireless base unit 108 receives signals from antenna enclosure system 104 and processes uplink and downlink data. Wireless base unit 108 may also contain a digital signal processor (DSP) used to convert signals received from receivers from analog to digital or vice versa.

In some examples, HMD 100 may further include a battery. The battery may connect to wireless base unit 108 to provide power to the wireless base unit 108 and the antenna enclosure system 104. The battery may be positioned on HMD 100. However, in some instances, the battery may be attached to the user's body, such as clipping onto clothes or placed in pockets of the user.

In other examples, HMD 100 further includes an additional cable to transfer the at least one of the data and power between wireless base unit 108 and body 102. The additional cable may comprise a Peripheral Component Interconnect Express (PCIe), an Optical Copper (Cu) Link (OCuLink) cable, a High-Definition Multimedia Interface (HDMI) cable, a Universal Serial Bus (USB) cable, or any other interface for exchanging data and/or power.

Cable 110 connects antenna enclosure system 104 to wireless base unit 108. Cable 110 exchanges power and/or data between antenna enclosure system 104 and wireless base unit 108. In some examples, cable 110 may comprise a coaxial cable. Coaxial cables provide more flexibility and reliability than flexible printing circuit (FPC). Cable 110 may also include a thermoplastic polyurethane (TPU) over old which covers the cable throughout the route from wireless base unit 108 to antenna enclosure 104 to strengthen by strain relief (SR) for increasing bending/twisting strength.

This design better accommodates different form factors than the integrated rigid antenna system for an HMD. Therefore, it is possible to make the wireless antenna system which universally fits all XR headsets. Furthermore, this design provides a line-of-sight of the antennas for the transmitter without compromising compactness.

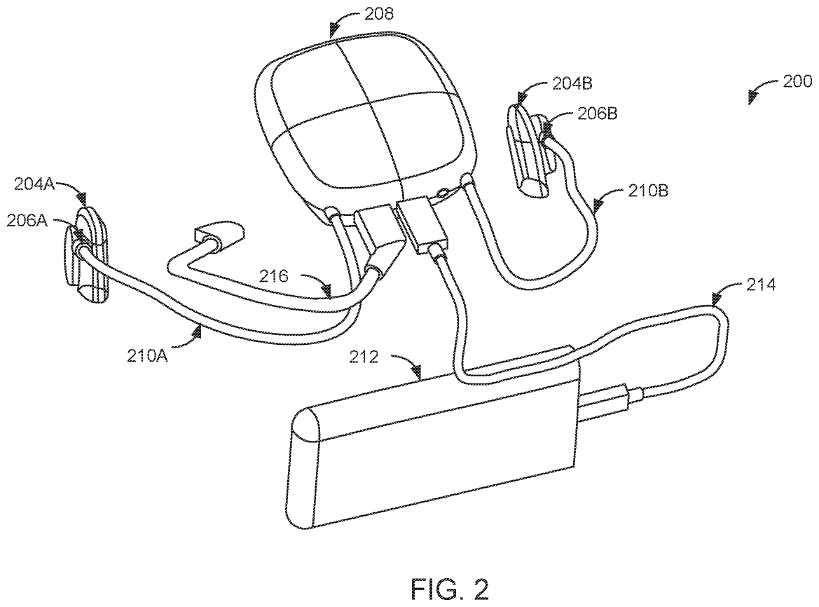

FIG. 2 is an exploded view of an antenna system for an HMD, according to an example. Antenna system 100 includes left antenna enclosure 204A and right antenna enclosure 204B. As illustrated in FIG. 2, left antenna enclosure 204A is positioned to the left of a user's head (not shown for clarity) and right antenna enclosure 204B is positioned to the right of the user's head (not shown for clarity). Left antenna enclosure 204A includes left RF connector 206A and right antenna enclosure 204A includes right RF connector 206B. Although not shown, left antenna enclosure 204A and right antenna enclosure 204B each include an antenna with an antenna board in which left antenna enclosure 204A and right antenna enclosure 204B reside.

Antenna system 100 further includes wireless base unit 208. Although not shown, wireless base unit 208 is positioned to the back of a users head. This allows antenna system 100 to be less bulky at the top of the user's head while still allowing left antenna enclosure 204A and right antenna enclosure 204B a line-of-sight to an external wireless antenna, such as an antenna included on a host computing device.

Wireless base unit 208 exchanges signaling with left RF connector 206A of left antenna enclosure 204A over left coaxial cable 210A. Wireless base unit 208 exchanges signaling with right RF connector 206B of right antenna enclosure 204B over right coaxial cable 210B. In some examples, left coaxial cable 210A and right coaxial cable 210B comprise TPU over molded cables to enable a higher strain relief when increased twisting and bending are applied to left coaxial cable 210A and right coaxial cable 210B.

Still referring to FIG. 2, antenna system 100 includes battery 212 which transfers power to wireless base unit 208 over power cord 214. Battery 212 may be located to the back of the user's head. However, battery 212 may be located in other areas of the user, such as on the user's clothes, in a user's pocket, strapped to a user's arms, etc. Finally, antenna system 100 includes data cable 216 connecting wireless base unit 208 to a body of the XR HMD (e.g., body 102 from FIG. 1) for data transmission.

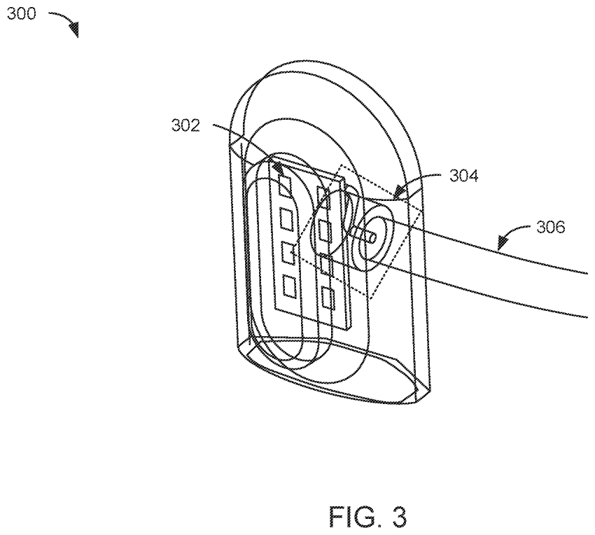

FIG. 3 is a perspective view of an example antenna enclosure for an antenna system of an HMD, according to an example. Antenna enclosure 300 includes antenna board 302, RF connector 304, and coaxial cable 306. As seen in FIG. 3, RF connector 304 attaches to the back of antenna board 302. Further coaxial cable 306 attaches to RF connector 304 on antenna board 302. Coaxial cable 306 may attach to RF connector using a clip or some other fastener. In some examples, coaxial cable 306 may include a TPU cable which covers coaxial cable 306 throughout the route from a main accessory piece (e.g., wireless base unit 108 and wireless base unit 208) to antenna enclosure 302.

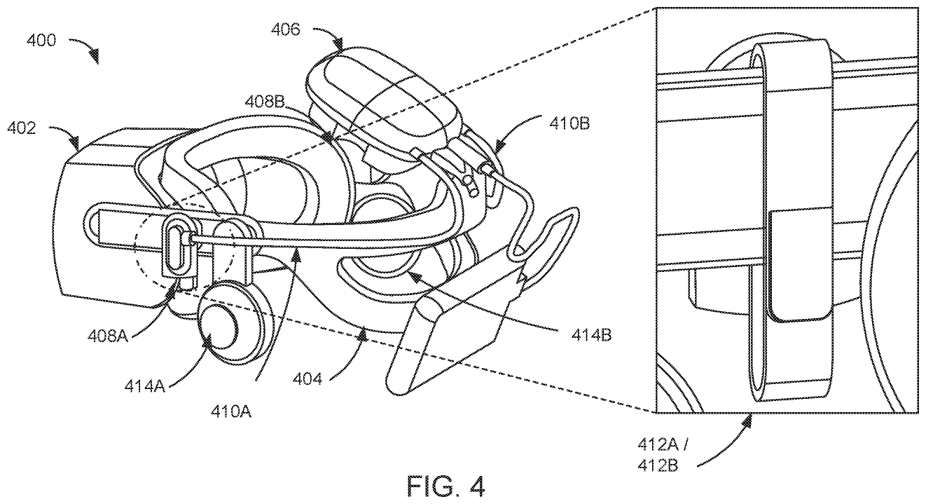

FIG. 4 is a perspective view of an example antenna enclosure system fastened to an XR HMD, according to an example, XR HMD 400 comprises body 402, head strap 404 coupled to body 402, and main accessory piece 406 housing a baseband unit. Main accessory piece 406 is attached to head strap 404 on a back side of a user's head.

XR HMD 400 further includes left antenna enclosure 408A coupled to main accessory piece 406 by left cable 410A. As illustrated in FIG. 4, left antenna enclosure 408A is attached to head strap 404 on a left side of the user's head by left fastener 412A. XR HMD 400 also includes right antenna enclosure 408B coupled to main accessory piece 406 by right cable 410B. Right antenna enclosure 408B is attached to head strap 410B on a right side of the users head by right fastener 412B. Although not shown for clarity, left antenna enclosure 408A and right antenna enclosure 408B may be attached to head strap 404 by attaching to left earpiece 414A and right earpiece 414B, respectively.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The FIG.s herein follow a numbering convention in which the first digit corresponds to the drawing FIG. number and the remaining digits identify an element or component in the drawing. For example, reference numeral 102 may refer to element 102 in FIG. 1 and an analogous element may be identified by reference numeral 202 in FIG. 2. Elements shown in the various FIG.s herein can be added, exchanged, and/or eliminated to provide additional examples of the disclosure. In addition, the proportion and the relative scale of the elements provided in the FIG.s are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A head mountable device (HMD) comprising:
a body;
an antenna enclosure system comprising:
a first antenna enclosure housing a first antenna, wherein the first antenna enclosure is positioned to a first side of the body;
a second antenna enclosure housing a second antenna, wherein the second antenna enclosure is positioned to a second side of the body;
a wireless base unit housing a baseband processor unit; and
a cable to transfer at least one of data and power between the wireless base unit and the antenna enclosure system.

2. The HMD of claim 1, wherein the first antenna enclosure and the second antenna enclosure each further house an antenna board having a radio frequency (RF) connector.

3. The HMD of claim 2, wherein the RF connector of the antenna board enclosed by each the first antenna enclosure and the second antenna enclosure is connected to the cable to transfer the at least one of the data and the power between the wireless base unit and the antenna enclosure system.

4. The HMD of claim 1, wherein the cable includes a thermoplastic polyurethane (TPU) overmold.

5. The HMD of claim 1, further comprising a first earpiece positioned on the first side of the body and a second earpiece positioned on the second side of the body, and wherein:
the first antenna enclosure is attached to the first earpiece positioned on the first side of the body; and
the second antenna enclosure is attached to the second earpiece positioned on the second side of the body.

6. The HMD of claim 1, further comprising a first side arm positioned on the first side of the body and a second sidearm positioned on the second side of the body, and wherein:
the first antenna enclosure is attached to the first sidearm positioned on the first side of the body; and
the second antenna enclosure is attached to the second sidearm positioned on the second side of the body.

7. The HMD of claim 1, wherein the antenna enclosure system is attached to the first side of the body and to the second side of the body with straps or dips.

8. The HMD of claim 1, further comprising:
a battery; and
a power cord to transfer power from the battery to the wireless base unit.

9. The HMD of claim 1, further comprising an additional cable to transfer the at least one of the data and power between the wireless base unit and the body of the HMD.

10. The HMD of claim 9, wherein the additional cable comprises a Peripheral Component Interconnect Express (PCIe), an Optical Copper (Cu) Link (OCuLink) cable, a High-Definition Multimedia Interface (HDMI) cable, or a Universal Serial Bus (USB) cable.

11. An antenna system for an extended reality (XR) head mounted display (HMD), comprising:
a wireless base unit, wherein the wireless base unit is located to a back side of a viewers head;
a data cable connecting the wireless base unit to a body of the XR HMD for data transmission;
a battery connected to the wireless base unit by a power cord;
a right antenna enclosure enclosing a right radio frequency (RE) connector which is communicately coupled to the wireless base unit by a right coaxial cable, wherein the right antenna enclosure is located to a right side of the viewer's head; and
a left antenna enclosure enclosing a right RF connector which is communicately to the wireless base unit by a left coaxial cable, wherein the left antenna enclosure is located to a left side of the viewer's head.

12. The antenna system of claim 11, wherein the data cable comprises an Optical Copper (Cu) Link (OCuLink) cable, a High-Definition Multimedia Interface (HDMI) cable, or a Universal Serial Bus (USB) cable.

13. The antenna system of claim 11, wherein:
the left antenna enclosure is located to the left side of the viewer's head by attaching the left antenna enclosure to a left earpiece of the XR HMD; and
the right antenna enclosure is located to the right side of the viewer's head by attaching the right antenna enclosure to a right earpiece of the XR HMD.

14. The antenna system of claim 11, wherein:
the left antenna enclosure is located to the left side of the viewer's head by attaching the left antenna enclosure to a left sidearm of the XR HMD; and
the right antenna enclosure is located to the right side of the viewer's head by attaching the right antenna enclosure to a right sidearm of the XR HMD.

15. An extended reality (XR) head mountable headset (HMD) comprising:
a body of the XR HMD;
a head strap coupled to the body of the XR HMD;
a main accessory piece housing a baseband unit, wherein the main accessory piece is attached to the head strap on a back side of a users head;
a right antenna enclosure coupled to the main accessory piece by a right cable, wherein the right antenna enclosure is attached to the head strap on a right side of the user's head by a right fastener; and
a left antenna enclosure coupled to the main accessory piece by a left cable, wherein the left antenna enclosure is attached to the head strap on a left side of the users head by a left fastener.
